(19) United States
(12) Patent Application Publication
(10) Pub. No.: US 2016/0160736 A1
(43) Pub. Date: Jun. 9, 2016

(54) WATER-COOLING INTERCOOLER APPARATUS

(71) Applicant: Hyundai Motor Company, Seoul (KR)

(72) Inventors: JongMan JUN, Hwaseong-si (KR); Hyoung Hyoun KIM, Hwaseong-si (KR)

(73) Assignee: Hyundai Motor Company, Seoul (KR)

(21) Appl. No.: 14/701,230

(22) Filed: Apr. 30, 2015

(30) Foreign Application Priority Data
Dec. 9, 2014 (KR) 10-2014-0175840

(51) Int. Cl. F01P 7/14; F01P 5/12; F01P 9/04; F02M 35/10; F01P 11/10; F01P 3/20

(52) U.S. Cl. CPC F01P 7/14; F01P 11/10; F01P 3/20; F01P 9/04; F02M 35/10157; F02M 35/10268; F01P 5/12; F01P 2003/001

(57) ABSTRACT

A water-cooling intercooler apparatus, may include a low-temperature radiator in which coolant flows to cool supercharged air supplied to an engine, wherein the low-temperature radiator is provided with an inlet into which the coolant flows, an outlet from which the coolant discharges, a body portion which is made of a plurality of connecting pipes for the coolant to flow therein, a first coolant tank configured to distribute the coolant to the plurality of connecting pipes, and a second coolant tank configured to collect the coolant; and at least one actuated-valves provided at the first or second coolant tank to open or close an inside of the first or second coolant tank for the coolant to flow in a portion of the plurality of connecting pipes.

### CROSS-REFERENCE TO RELATED APPLICATION

The present application claims priority to and the benefit of Korean Patent Application No. 10-2014-0175840 filed on Dec. 9, 2014, the entire contents of which is incorporated herein for all purposes by this reference.

### BACKGROUND OF THE INVENTION

1. Field of the Invention

The present invention relates to a water-cooling intercooler apparatus, and more particularly, to a water-cooling intercooler apparatus that may add a bypass actuated-valve to a low-temperature radiator of the water-cooling intercooler apparatus and change coolant flowing paths and/or the number of coolant flowing paths if necessary to be able to vary a coolant flowing amount, thereby reducing power consumption of an electric water pump configured to circulate coolant, and fuel consumption.

2. Description of Related Art

Engine power for a vehicle is controlled based on an air/fuel ratio.

There are many methods to inject fuel into an engine, and many methods to draw air into the engine.

An engine for a vehicle was first developed as a naturally aspirated engine, and improved engines such as a turbocharged engine, a turbo intercooled engine, etc. are being developed for increasing engine power, improving fuel efficiency, and reducing exhaust gas emissions.

A turbo intercooler or an intercooler included in the turbo intercooler engine is an apparatus that increases engine power by increasing air density through cooling compressed high-temperature air therein to increase an intake air amount that is supplied to a cylinder of an engine.

The turbo intercooler engine provided with the intercooler generates even higher engine power than the naturally aspirated engine, and has various merits such as a long lifespan, reduction of vibration, noise, and exhaust gas, and enhancement of fuel efficiency because of having excellent power performance at a low speed.

An intercooler apparatus that includes the intercooler and is applied to the turbo intercooler engine may have a similar structure to that of a radiator. Intercooler apparatuses are classified into an air-cooling intercooler apparatus and a water-cooling intercooler apparatus. The air-cooling intercooler apparatus cools air supplied or supercharged to an engine using air flowing into an engine compartment of a vehicle while the vehicle is running, and the water-cooling intercooler apparatus cools air supplied or supercharged to the engine using a coolant.

The air-cooling intercooler apparatus has a simpler structure than that of the water-cooling intercooler apparatus, but has inferior cooling efficiency.

The water-cooling intercooler apparatus has a structure that circulates a coolant of a radiator for an engine or a coolant of an exclusive radiator to cool supercharged air (high-temperature compressed air).

Compared with a supercharged air route of the air-cooling intercooler apparatus, a supercharged air route of the water-cooling intercooler apparatus may be shortened, thus the supercharged air responsiveness thereof may be improved due to reduction of the supercharged air resistance. In addition, according to the water-cooling intercooler apparatus, fuel efficiency and performance may be improved by cooling the supercharged air using a coolant with a large heat capacity.

As is well-known to a person skilled in the art, the faster the flow of the coolant is and the higher the temperature difference between the supercharged air and the coolant is, the better the cooling efficiency of the water-cooling intercooler apparatus is.

A low-temperature radiator of the water-cooling intercooler apparatus may be, as shown in FIG. 1, a U-shaped flowing structure in which a coolant inlet 64 and a coolant outlet 65 are formed in the same direction so that a coolant flows in a U-shaped path. In addition, the low-temperature radiator of the water-cooling intercooler apparatus may be, as shown in FIG. 2, an I-shaped flowing structure in which a coolant inlet 64a and a coolant outlet 65a are formed in opposite directions so that coolant flows in an I-shaped path.

Referring to FIGS. 1 and 2, referred to by reference numeral 60 in FIG. 1 and reference numeral 60a in FIG. 2, a low-temperature radiator of a water-cooling intercooler apparatus according to the conventional art is provided with coolant tanks (or head tanks) 61 and 62 which are formed at opposite sides of the low-temperature radiator. One coolant tank 61 is connected to the other coolant tank 62 by a thin metal connecting pipe 63 at which cooling fins are formed. Each of the inlets 64 and 64a and the outlets 65 and 65a of the coolant tanks 61 and 62 is connected to an electric water pump (WP) for circulating coolant.

As shown in FIG. 1 or 2, supercharged air supplied to an engine is cooled by the coolant that flows to the left and right in FIG. 1, or to the right in FIG. 2, in the low-temperature radiator 60 or 60a of the water-cooling intercooler apparatus.

However, since the low-temperature radiator of the water-cooling intercooler apparatus according to the conventional art is designed and manufactured with a fixed maximum capacity to satisfy cooling performance even in the worst conditions, excess coolant may flow due to an engine state, thereby increasing power consumption of an electric water pump resulting in an increase of fuel consumption.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a water-cooling intercooler apparatus that may add a bypass actuated-valve to a low-temperature radiator of the water-cooling intercooler apparatus and change coolant flowing paths and/or the number of coolant flowing paths if necessary to be able to vary a coolant flowing amount, thereby reducing power consumption of an electric water pump configured to circulate coolant, and fuel consumption.

An exemplary embodiment of the present invention provides a water-cooling intercooler apparatus including: a low-temperature radiator in which a coolant flows to cool supercharged air supplied to an engine, wherein the low-temperature radiator is provided with an inlet into which the coolant flows, an outlet from which the coolant discharges, a body portion which is made of a plurality of connecting pipes for the coolant to flow therein, a first coolant tank configured to distribute the coolant to the plurality of connecting pipes, and a second coolant tank configured to collect the coolant; and one or more actuated-valves configured to be provided at the first or second coolant tank to open or close an inside of the first or second coolant tank for the coolant to flow in some of the plurality of connecting pipes.

When the low-temperature radiator is made of a U-shaped flowing structure and the actuated-valve is provided at the second coolant tank at which the inlet is not provided, a partition wall may be formed in the second coolant thank at which the inlet is provided.

When the low-temperature radiator is made of the U-shaped flowing structure and the inside of the second coolant tank is closed by the actuated-valve, a first bypass outlet may be adjacently formed at the actuated-valve to make the coolant flow towards the outlet.

A first bypass inlet, which is connected to the first bypass outlet, may be formed at the outlet of the first coolant tank.

When the low-temperature radiator is made of an I-shaped flowing structure, each of the first and second coolant tanks may be provided with the actuated-valve.

When the low-temperature radiator is made of the I-shaped flowing structure and the insides of the first and second coolant tanks are closed by the actuated-valve, a second bypass outlet may be adjacently formed at the actuated-valve provided at the second coolant tank, wherein the outlet is provided at the second coolant tank and the second bypass outlet is configured to make the coolant flow towards the outlet of the second coolant tank.

A second bypass inlet may be formed at the outlet of the second coolant tank to be connected to the second bypass outlet.

As described above, according to an embodiment of the present invention, a water-cooling intercooler apparatus may be provided to add a bypass actuated-valve to a low-temperature radiator of the water-cooling intercooler apparatus and change coolant flowing paths and/or the number of coolant flowing paths if necessary to be able to vary a coolant flowing amount, thereby reducing power consumption of an electric water pump configured to circulate coolant, and fuel consumption.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram illustrating a typical water-cooling intercooler apparatus of a U-shaped flowing structure.

FIG. 2 is a schematic diagram illustrating a typical water-cooling intercooler apparatus of an I-shaped flowing structure.

FIG. 3 is a schematic diagram of a water-cooling intercooler apparatus according to an exemplary embodiment of the present invention.

FIG. 4 and FIG. 5 are schematic diagrams for explaining operation of a water-cooling intercooler apparatus according to a various exemplary embodiments of the present invention.

FIG. 6 and FIG. 7 are schematic diagrams for explaining operation of a water-cooling intercooler apparatus according to a various exemplary embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In addition, in the specification, unless explicitly described to the contrary, the word “comprise” and variations such as “comprises” or “comprising” will be understood to imply the inclusion of stated elements but not the exclusion of any other elements.

Like reference numerals designate like elements throughout the specification.

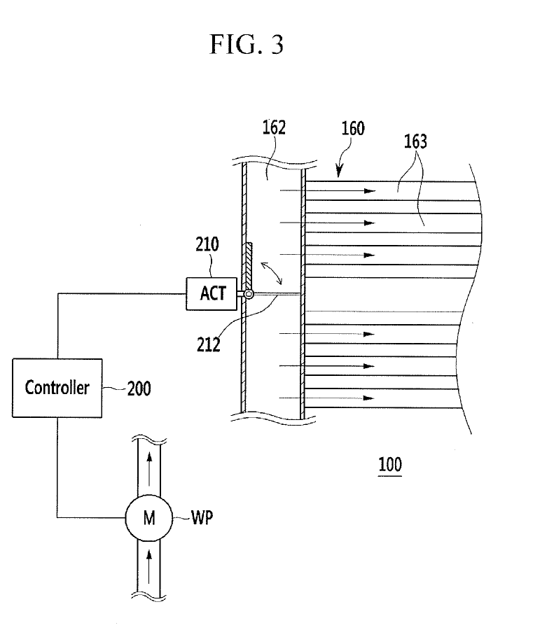

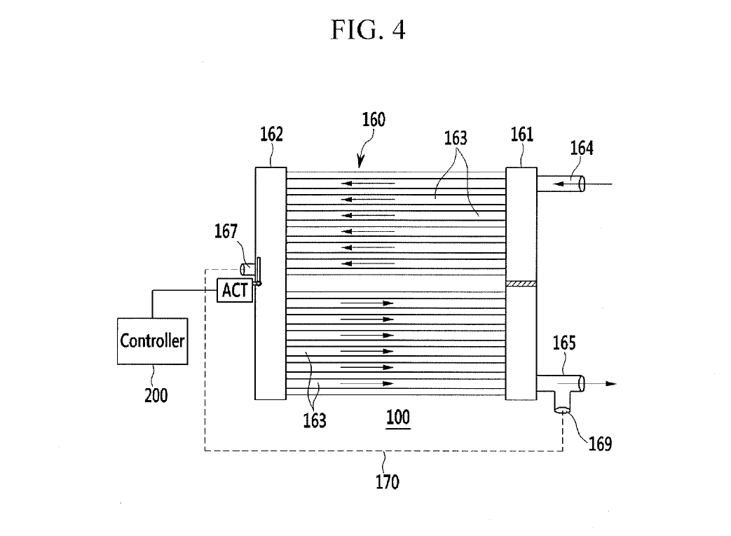

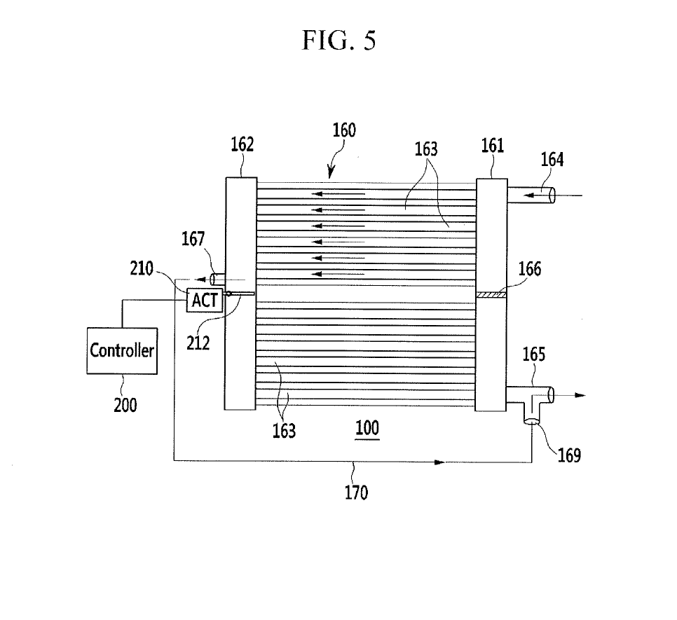

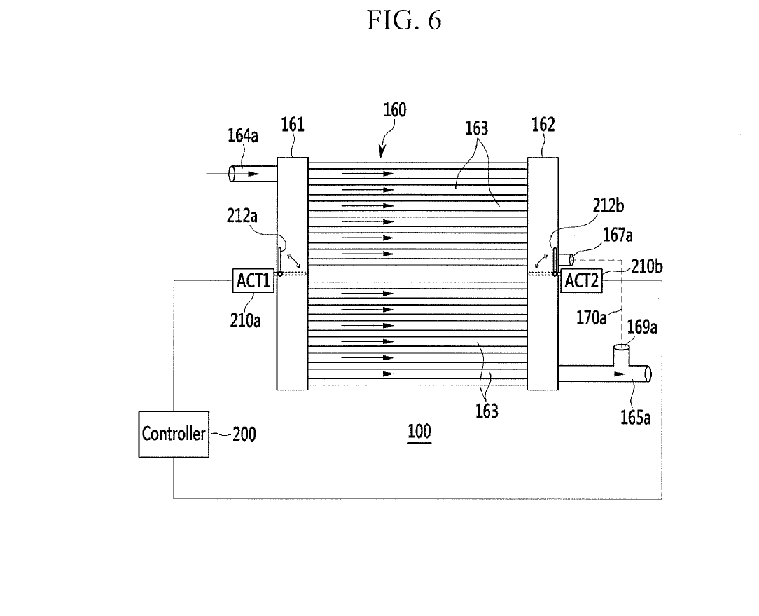

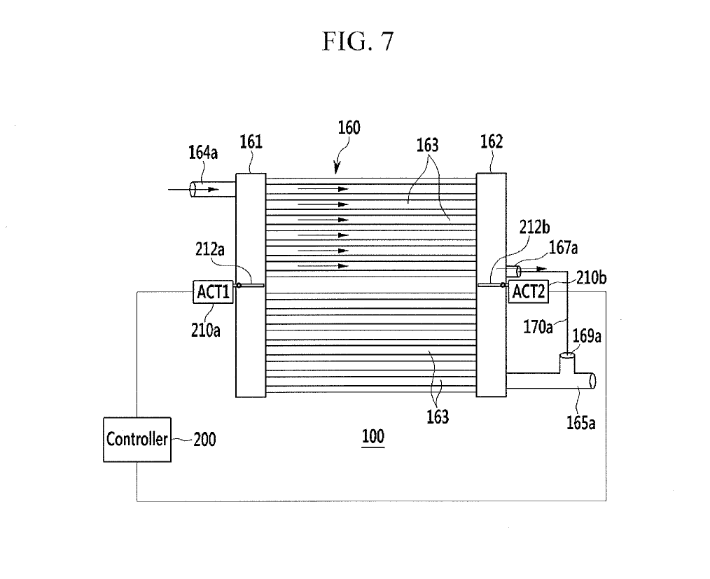

FIG. 3 is a schematic diagram of a water-cooling intercooler apparatus according to an exemplary embodiment of the present invention, FIGS. 4 and 5 are schematic diagrams for explaining operation of a water-cooling intercooler apparatus according to a first exemplary embodiment of the present invention, and FIGS. 6 and 7 are schematic diagrams for explaining operation of a water-cooling intercooler apparatus according to a second exemplary embodiment of the present invention.

Referring to FIGS. 3 to 7, the water-cooling intercooler apparatus according to an exemplary embodiment of the present invention includes: a low-temperature radiator 100 in which coolant flows to cool supercharged air supplied to an engine , wherein the low-temperature radiator 100 is provided with an inlet 164 (164a) into which the coolant flows, an outlet 165 (165a) from which the coolant discharges, a body portion 160 which is made of a plurality of connecting pipes 163 for the coolant to flow therein, a first coolant tank 161 configured to distribute the coolant to the plurality of connecting pipes 163, and a second coolant tank 162 configured to collect the coolant, and one or more actuated-valves 210 (210a and 210b) configured to be provided at the first or second coolant tank 161 or 162 to open or close an inside of the first or second coolant tank 161 or 162 for the coolant to flow in some of the plurality of connecting pipes 163.

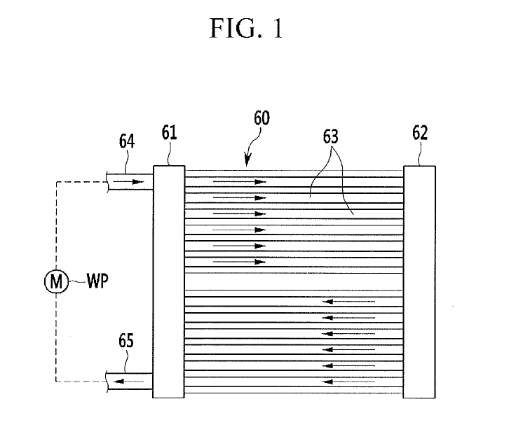

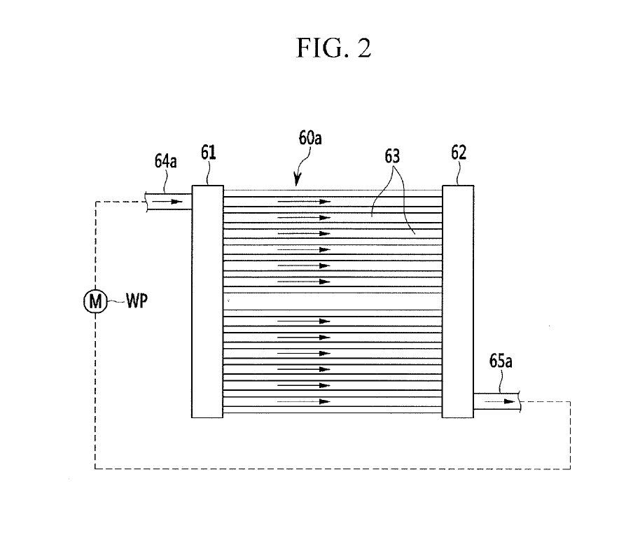

The inlet 164 and the outlet 165 are associated with the water-cooling intercooler apparatus of a U-shaped flowing structure, and the inlet 164a and the outlet 165b are associated with the water-cooling intercooler apparatus of an I-shaped flowing structure. As shown in FIG. 1 or 2, the inlet 164 or 164a may correspond to the inlet provided in the conventional low-temperature radiator.

The actuated-valves 210 (210a and 210b) may be those that can open or close the coolant tanks 161 and 162, and which may correspond to the well-known actuated-valves, as is well-known to a person skilled in the art.

The actuated-valves 210 (210a and 210b) may be controlled by a controller 200, and the insides of the coolant tanks 161 and 162 may be opened or closed by an opening/closing plate 212 (212a, and 212b) depending on operation of the actuated-valve 210 (210a and 210b).

The controller 200 may be included in an engine electronic control unit (ECU) that controls an engine (not shown), or may be included in a controller that controls a water-cooling intercooler apparatus.

As shown in FIGS. 4 and 5, when the low-temperature radiator 100 is formed in the U-shaped flowing structure, the actuated-valve 210 is provided in the second coolant tank 162 at which the inlet 164 is not provided, and a partition wall 166 is formed in the first coolant tank 161 at which the inlet 164 is provided.

The partition wall 166 may correspond to a partition wall formed at a coolant tank provided in the conventional low-temperature radiator. The partition wall 166 may be positioned as high as the opening/closing plate 212 of the actuated-valve 210.

As shown in FIG. 5, when the low-temperature radiator 100 is made of the U-shaped flowing structure in which the inside of the second coolant tank 162 is closed by the opening/closing plate 212 of the actuated-valve 210, a first bypass 167 may be adjacently formed at the actuated-valve 210 to make the coolant flow in the outlet 165 of the first coolant tank 161. The first bypass outlet 167 may be formed at an upper portion of the actuated-valve 210.

A first bypass inlet 169, which is connected to the first bypass outlet 167, may be formed at the outlet 165 of the first coolant tank. The first bypass outlet 167 and the first bypass inlet 169 may be connected to each other through a connecting member such as a hose , as is well-known to a person skilled in the art.

Meanwhile, when the low-temperature radiator 100 is made of the I-shaped flowing structure, each of the first and second coolant tanks 161 and 162 may be provided with actuated-valves 210a and 210b.

The actuated-valves 210a and 210b may be those that are shown in FIGS. 4 and 5. Reference numerals 212a and 212b designate opening/closing plates of the actuated-valves 210a and 210b to open or close the coolant tanks 161 and 162, respectively.

When the low-temperature radiator 100 is made of the I-shaped flowing structure and the insides of the first and second coolant tanks 161 and 162 are closed by the opening/closing plates 212a and 212b of the actuated-valves 210a and 210b, a second bypass outlet 167a may be adjacently formed at the actuated-valve 210b provided at the second coolant tank 162, wherein the outlet 165a is provided at the second coolant tank 162, and the second bypass outlet 167a is configured to make the coolant flow in the outlet 165a of the second coolant tank 162. The second bypass outlet 167a may be formed at an upper portion of the actuated-valve 210b.

A second bypass inlet 169a, which is connected to the second bypass outlet 167a, may be formed at the outlet 165a of the second coolant tank 162. The first bypass outlet 167 and the first bypass inlet 169 may be connected to each other through a connecting member such as a hose , as is well-known to a person skilled in the art.

Hereinafter, a water-cooling intercooler apparatus according to an exemplary embodiment of the present invention will be described in detail with reference to the accompanying drawings.

Referring to FIG. 4, when it is required to cool supercharged air supplied to the engine through all the connecting pipes 163, the controller 200 operates the actuated-valve 210 to open the opening/closing plate 212.

When the opening/closing plate 212 of the actuated-valve 210 is opened, since the low-temperature radiator 100 is in the same state as shown in FIG. 1 and operates the same as in FIG. 1, the description thereof will be omitted.

Referring to FIG. 5, when the supercharged air supplied to the engine can be fully cooled using some of the connecting pipes 163, the controller 200 controls or operates the actuated-valve 210 so that the opening/closing plate 212 can close the inside of the coolant tank 162. For this purpose, the partition wall 166 may be provided as high as the opening/closing plate 212 of the actuated-valve 210.

When the opening/closing plate 212 of the actuated-valve 210 closes the inside of the coolant tank 162, as shown in FIG. 5, coolant flows in connecting pipes 163 only positioned at an upper portion of the actuated valve 210. In other words, the coolant flows as it flows in the I-shaped flowing structure of the low-temperature radiator, thus an amount of flowing coolant becomes small and flow resistance also becomes low, thereby power consumption of the electric water pump (WP) and fuel consumption decrease.

The coolant discharged from the first bypass outlet 167 flows into the first bypass inlet 169 through a connecting member such as a hose, and then is discharged from the outlet 165.

Referring to FIG. 6, when it is required to cool supercharged air supplied to the engine through all the connecting pipes 163, the controller 200 controls or operates the actuated-valve 210a and 210b to open the opening/closing plates 212a and 212b.

When the opening/closing plates 212a and 212b of the actuated-valve 210 are opened, since the low-temperature radiator 100 is in the same state as shown in FIG. 2 and operates the same as in FIG. 2, the description thereof will be omitted.

Referring to FIG. 7, when the supercharged air supplied to the engine can be fully cooled using some of the connecting pipes 163, the controller 200 controls or operates the actuated-valves 210a and 210b so that the opening/closing plates 212a and 212b can close the inside of the coolant tank 162 For this purpose, the actuated-valves 210a and 210b are positioned at the same height.

When the opening/closing plate 212 of the actuated-valve 210 closes the respective insides of the coolant tanks 161 and 162, as shown in FIG. 7, since coolant flows in the connecting pipes 163 only positioned at an upper portion of the actuated valves 210a and 210b, an amount of flowing coolant becomes small, thereby power consumption of the electric water pump (WP) and fuel consumption decrease.

The coolant discharged from the second bypass outlet 167a flows into the second bypass inlet 169a through a connecting member such as a hose, and then is discharged from the outlet 165a.

Therefore, according to the exemplary embodiment of the present invention, it is possible to add a bypass actuated-valve to a low-temperature radiator of the water-cooling intercooler apparatus and change coolant flowing paths and/or the number of coolant flowing paths as necessary to be able to vary a coolant flowing amount, thereby reducing power consumption of an electric water pump configured to circulate coolant, and fuel consumption.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. A water-cooling intercooler apparatus, comprising:
a low-temperature radiator in which coolant flows to cool supercharged air supplied to an engine, wherein the low-temperature radiator is provided with an inlet into which the coolant flows, an outlet from which the coolant discharges, a body portion which is made of a plurality of connecting pipes for the coolant to flow therein, a first coolant tank configured to distribute the coolant to the plurality of connecting pipes, and a second coolant tank configured to collect the coolant; and
at least one actuated-valves provided at the first or second coolant tank to open or close an inside of the first or second coolant tank for the coolant to flow in a portion of the plurality of connecting pipes.

2. The water-cooling intercooler apparatus of claim 1, wherein
when the low-temperature radiator is made of a U-shaped flowing structure and the at least one actuated-valve is provided at the second coolant tank at which the inlet is not provided, a partition wall is formed in the second coolant thank at which the inlet is provided.

3. The water-cooling intercooler apparatus of claim 2, wherein
when the low-temperature radiator is made of the U-shaped flowing structure and the inside of the second coolant tank is closed by the at least one actuated-valve, a first bypass outlet is adjacently formed at the at least one actuated-valve to make the coolant flow towards the outlet.

4. The water-cooling intercooler apparatus of claim 3, wherein
a first bypass inlet is formed at the outlet of the second coolant tank to be connected to the first bypass outlet.

5. The water-cooling intercooler apparatus of claim 1, wherein
when the low-temperature radiator is made of an I-shaped flowing structure, each of the first and second coolant tanks is provided with the at least one actuated-valve.

6. The water-cooling intercooler apparatus of claim 5, wherein
when the low-temperature radiator is made of the I-shaped flowing structure and the insides of the first and second coolant tanks are closed by the at least one actuated-valve, a second bypass outlet is adjacently formed at the at least one actuated-valve provided at the second coolant tank, wherein the outlet is provided at the second coolant tank and the second bypass outlet is configured to make the coolant flow towards the outlet of the second coolant tank.

7. The water-cooling intercooler apparatus of claim 6, wherein
a second bypass inlet is formed at the outlet of the second coolant tank to be connected to the second bypass outlet.
